(19) United States
(12) Patent Application Publication
(10) Pub. No.: US 2003/0065651 A1
(43) Pub. Date: Apr. 3, 2003

(54) Apparatus, method, program, and recording medium for ingredient information management

(75) Inventor: Kumiko Naito, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/091,148

(22) Filed: Mar. 6, 2002

(30) Foreign Application Priority Data
Sep. 28, 2001 (JP) 2001-303711

(51) Int. Cl. G06F 7/00

(52) U.S. Cl. 707/3

(57) ABSTRACT

A conventional ingredient information management apparatus has a problem that a combination of the information about new dishes using the ingredients remaining at the last cooking cannot be obtained before setting the conditions, including the ingredients remaining, at the last cooking.

The problem is solved by an ingredient information management apparatus having a means for computing the information about new dishes using the ingredients assumed to remain at the last cooking based on the menu discrimination information from a member received by the ingredient information management apparatus, and the distribution date DB 111, menu DB 120, sale unit DB 150, member DB 130, and shop DB.

### BACKGROUND OF THE INVENTION

1. Field of the Invention

The present invention relates to an apparatus, method, program, and recording medium for managing a combination of information about the ingredients of dishes, etc.

2. Description of the Related Art

A conventional ingredient information management apparatus manages only a combination of the information about the ingredients of dishes, etc. computed based on the conditions set every time a user inquires.

Furthermore, a conventional shop terminal manages only the combination of the information received from the ingredient information management apparatus.

[Problems to be Solved by the Invention]

A first problem is that the conventional ingredient information management apparatus manages only a combination of the information about the ingredients of dishes, etc. computed based on the conditions set every time a user inquires, thus being not able to obtain, for example, the information about new dishes using the ingredients which remain from the last cooking before setting the conditions including the ingredients which remain from the last cooking.

A second problem is that the conventional shop terminal manages only a combination of the information received from the ingredient information management apparatus, thus being not able to use the combination of the information as direct sales supporting information.

### SUMMARY OF THE INVENTION

[Means for Solving the Problems]

The first problem is solved by an ingredient information management apparatus comprising: a means for receiving the menu discrimination information input through member terminals; a menu storage means for storing discrimination information and amounts of ingredients corresponding to the discrimination information for every menu; an ingredient amount searching means for searching out the ingredients and the amounts thereof, from the menu storage means, corresponding to said menu discrimination information; a sale unit storage means for storing a sale unit for every ingredient; a sale unit searching means for searching out a sale unit, from the sale unit storage means, corresponding to an ingredient searched out by the ingredient amount searching means; a comparing means for comparing the amount of said ingredient searching out by the ingredient amount searching means with the sale unit searched by the sale unit searching means; and a menu information searching means for searching out the menu information, from the menu storage means, including said ingredient in case that said amount of said ingredient is less than said sale unit as a result of the comparison.

The second problem is solved by a shop terminal comprising: a successful sale coefficient storage means for storing the successful sale coefficient representing the probability of purchasing the ingredients of a first menu and the successful sale coefficient representing the probability of purchasing the ingredients of a second menu inquired in relation to the first menu; a means for computing the expected sales of the ingredients of the first menu based on the ingredients of the first menu, the number of the distributions of the first menu, and the successful sale coefficient of the first menu searching out, from the successful sale coefficient storage means; and a means for computing the expected sales of the ingredients of the second menu based on the ingredients of the second menu, number of the inquiries of the second menu, and the successful sale coefficient of the second menu searched out, from the successful sale coefficient storage means.

### BRIEF DESCRIPTION OF THE DRAWINGS

FIG. 1 shows the system configuration of an embodiment of the present invention.

FIG. 2 is a flow chart depicting the whole flow of the process of inquiring to obtain menus using ingredients remaining from the previous menu.

FIG. 3 is a flow chart depicting the flow of the process of inquiring to obtain available menus using remaining ingredients.

FIG. 4 is a flow chart depicting the flow of the process of searching out useful ingredients from the remaining ingredients.

FIG. 5 is a flow chart depicting the flow of the process of searching out an available menu using remaining ingredients.

FIG. 6 shows a distribution date DB.

FIG. 7A and FIG. 7B show a menu DB.

FIG. 8 shows a sale unit DB.

FIG. 9 shows a member DB.

FIG. 10 shows a shop DB.

FIG. 11A to FIG. 11D show examples of the image on the screen of a member terminal.

FIG. 12A and FIG. 12B show examples of the image on the screen of a member terminal.

FIG. 13 shows a stock-for-network-sale DB.

FIG. 14 shows a successful sale coefficient DB.

FIG. 15 is a flow chart depicting the flow of a sales supporting message outputting process.

FIG. 16 shows an example of the contents of the memory for computing expected sales.

FIG. 17 shows an example of the image on the screen of a shop terminal.

### DESCRIPTION OF THE PREFERRED EMBODIMENTS

An embodiment of an ingredient information managing apparatus according to the present invention is described in detail below.

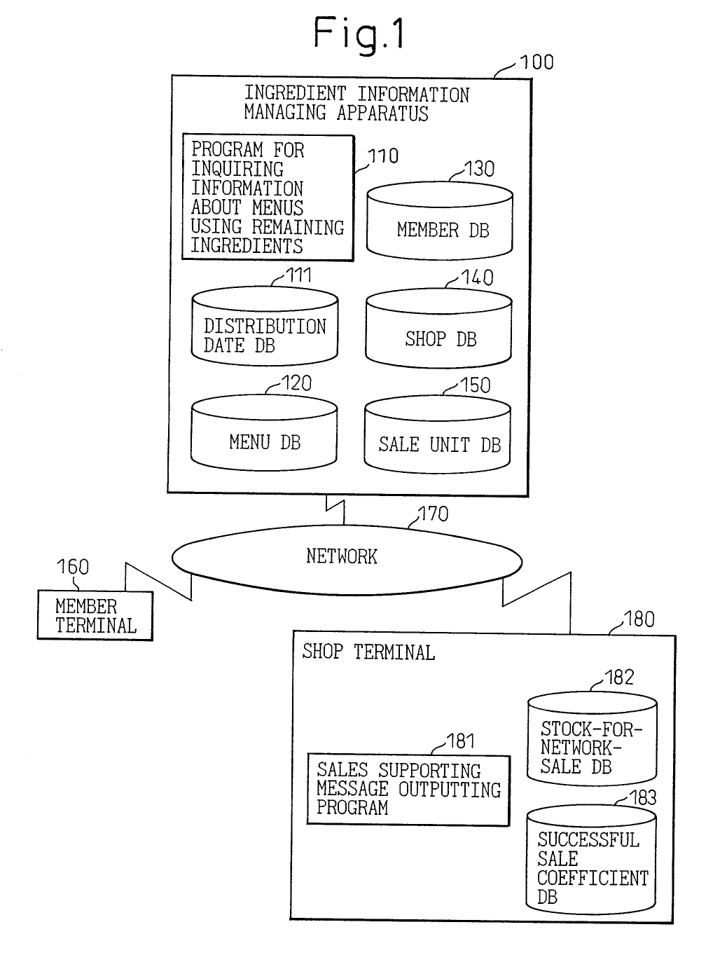

FIG. 1 shows the system configuration of this embodiment. In this figure, to the ingredient information managing apparatus 100, one or more member terminals 160 operated by members and one or more shop terminals 180 operated by clerks are connected via a network 170.

The ingredient information managing apparatus 100 is a computer having a processor and a memory, and is placed in, for example, an ingredient information managing center where the information such as ingredients of dishes, etc. is managed. This information may be accessed from both of the member terminals and the shop terminals. The apparatus 100 has five DBs (databases) including a distribution date DB 111 whose components will be described later, a menu DB 120, a member DB 130, a shop DB 140, and a sale unit DB 150, and a program 110 for inquiring to obtain menus using remaining ingredients from the previous menu, which receives the distribution date of the last cooking information from a member, and searches for, while referring each of the above DBs, the information about new dishes using the ingredients presumed to remain when preparing the last dish.

The components of the distribution date DB 111 are distribution dates and all menus distributed to the members and the shops on the distribution dates. The components of the menu DB 120 are menu names, ingredients necessary to prepare the menus, the amounts of the ingredients, seasonings necessary for the menus, the amounts of the seasonings, and the recipes for the menus. The components of the member DB 130 are the names and Email addresses of the members. The components of the shop DB 140 are the names and E-mail addresses of the shops. The components of the sale unit DB 150 are the names and sales forms of ingredients.

The shop terminal 180 is a computer having a processor and a memory, and is placed in, for example, a shop where the ingredient information managing apparatus 100 may be accessed through the shop terminal 180. The shop terminal 180 has two DBs including a stock-for-network-sale DB 182 and a successful sale coefficient DB 183, and a sales supporting message outputting program 181 which receives, from the ingredient information managing apparatus 100, the information about dishes and the information about new dishes using the ingredients presumed to remain when preparing the last dish, and outputs sales supporting messages based on the received information.

The components of the stock-for-network-sale DB 182 are the names of merchandises and the amounts of the stocks of the merchandises. The components of the successful sale coefficient DB 183 are the names of merchandises, the successful sale coefficients of recommended menus, and the successful sale coefficients of the menus using remaining ingredients.

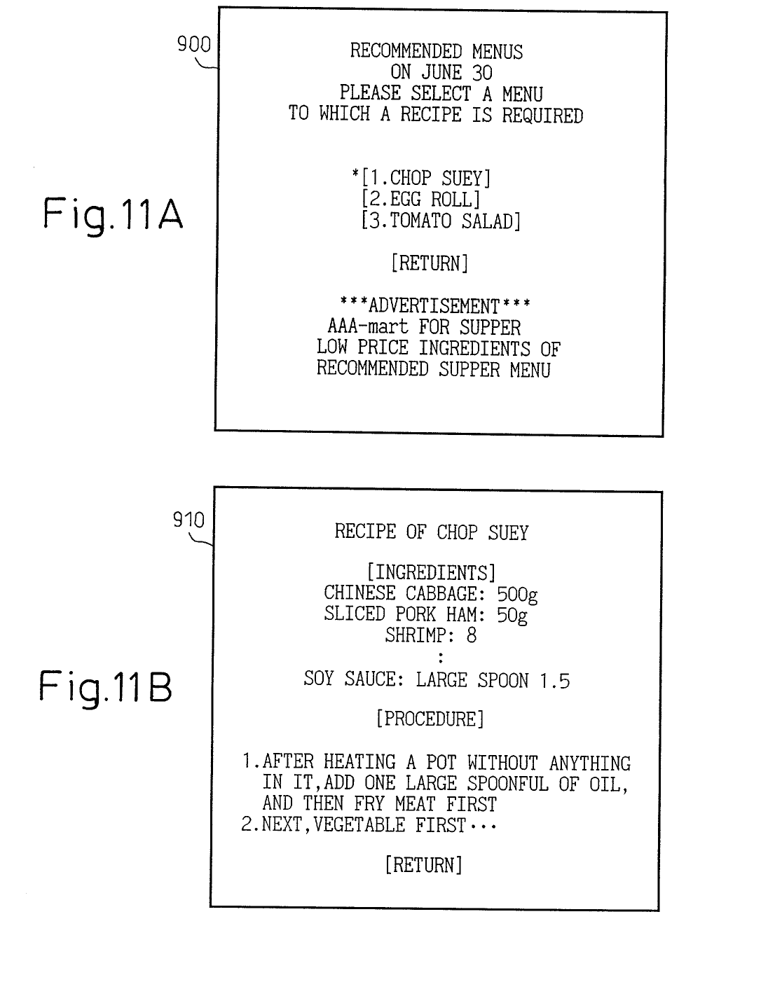

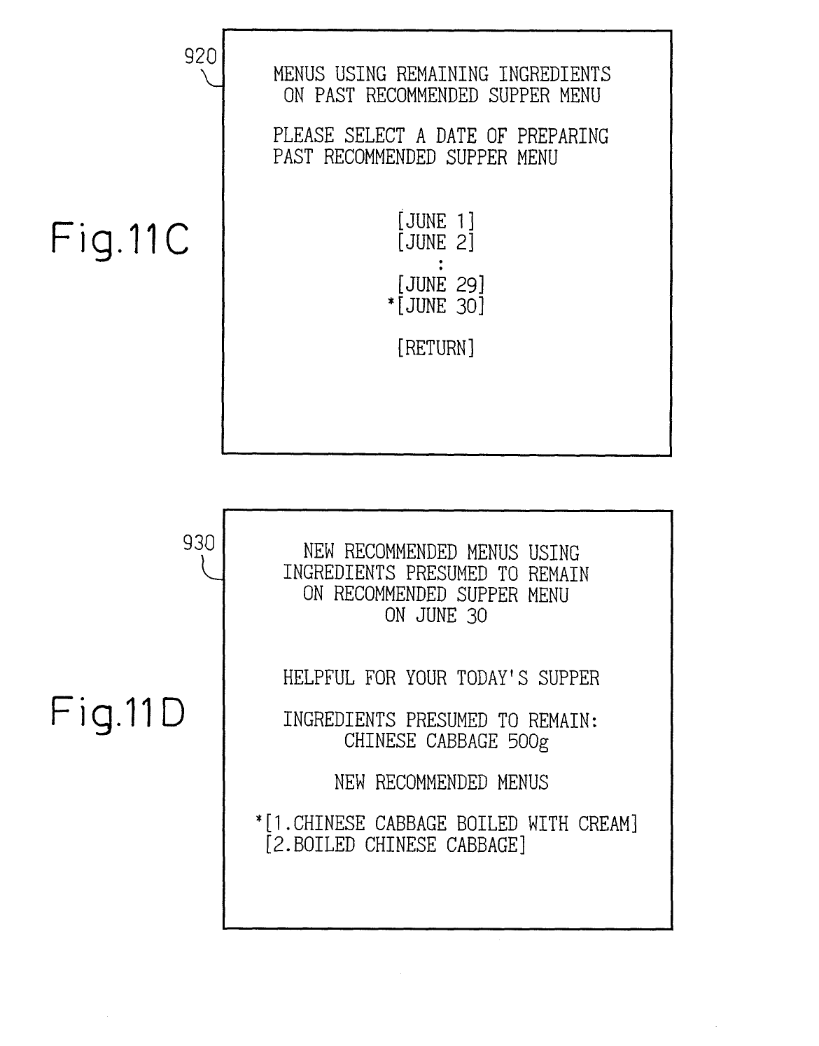

Below is described, with reference to FIG. 1 to FIG. 10, FIG. 11A to FIG. 11D, and FIG. 12A and FIG. 12B, the process of receiving the information about the last dish from a member, and computing, by referring the menu DB 120, member DB 130, shop DB 140, and sale unit DB 150, the information about the new dishes using the ingredients presumed to remain when preparing the last dish.

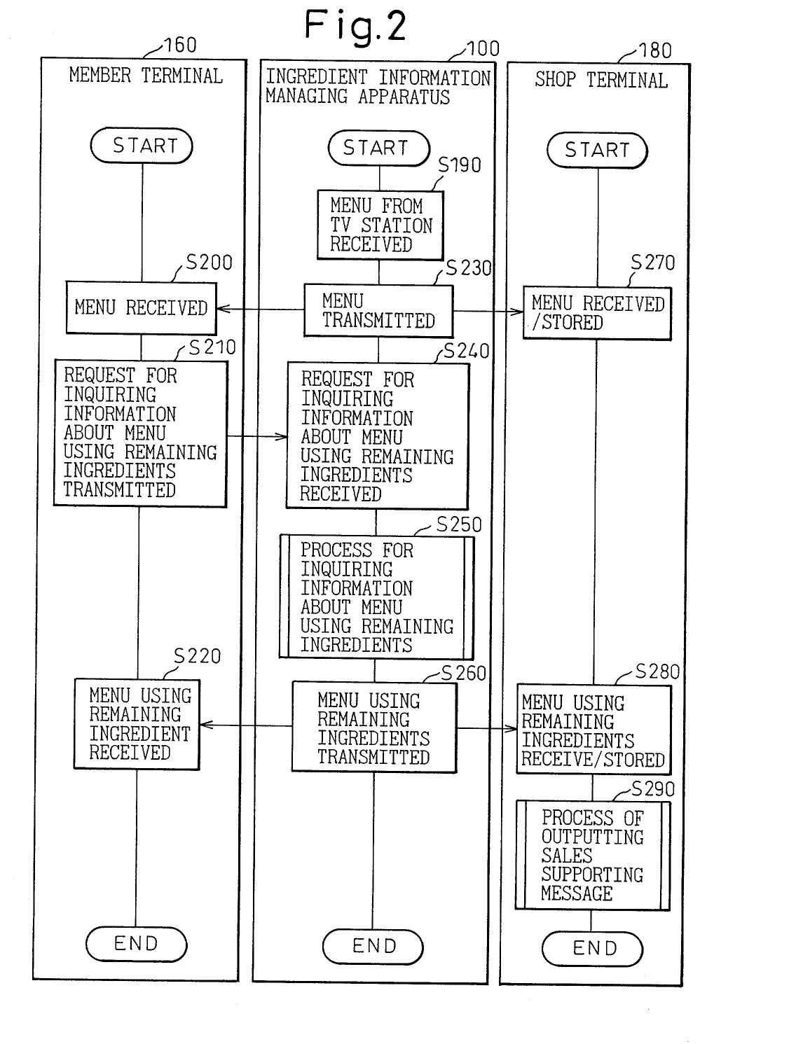

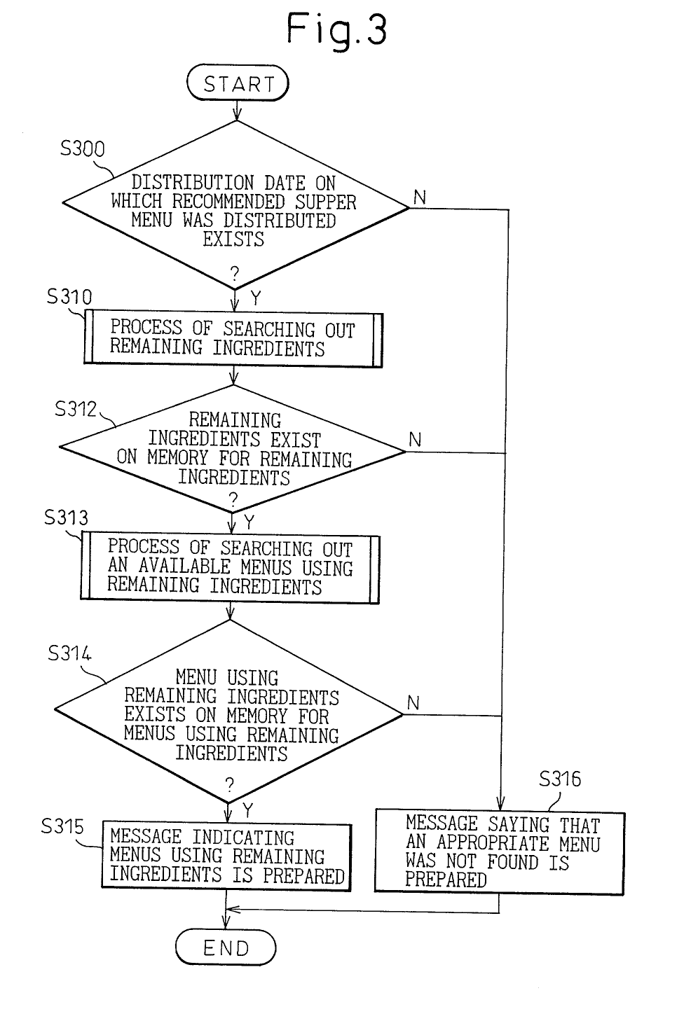

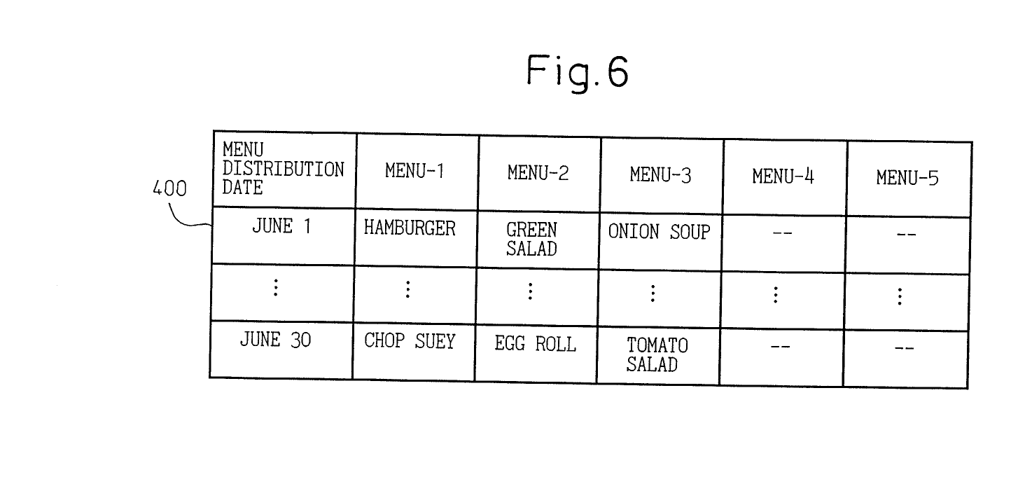

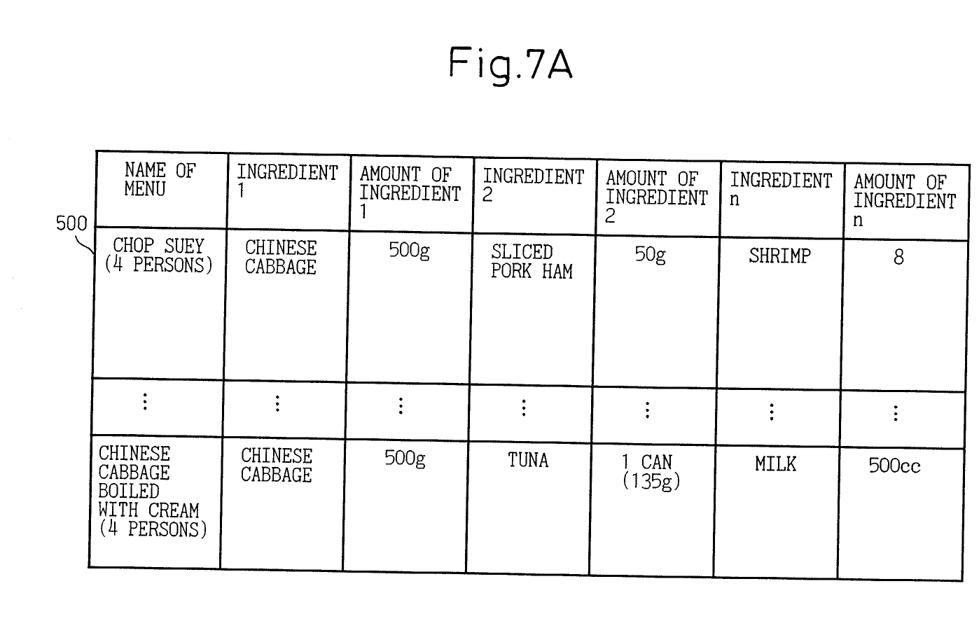

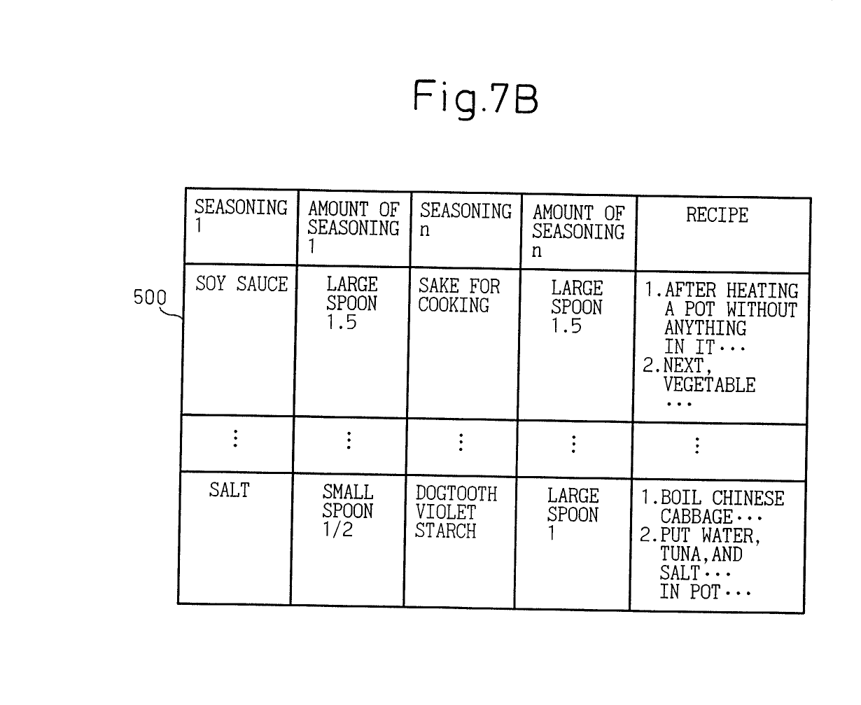

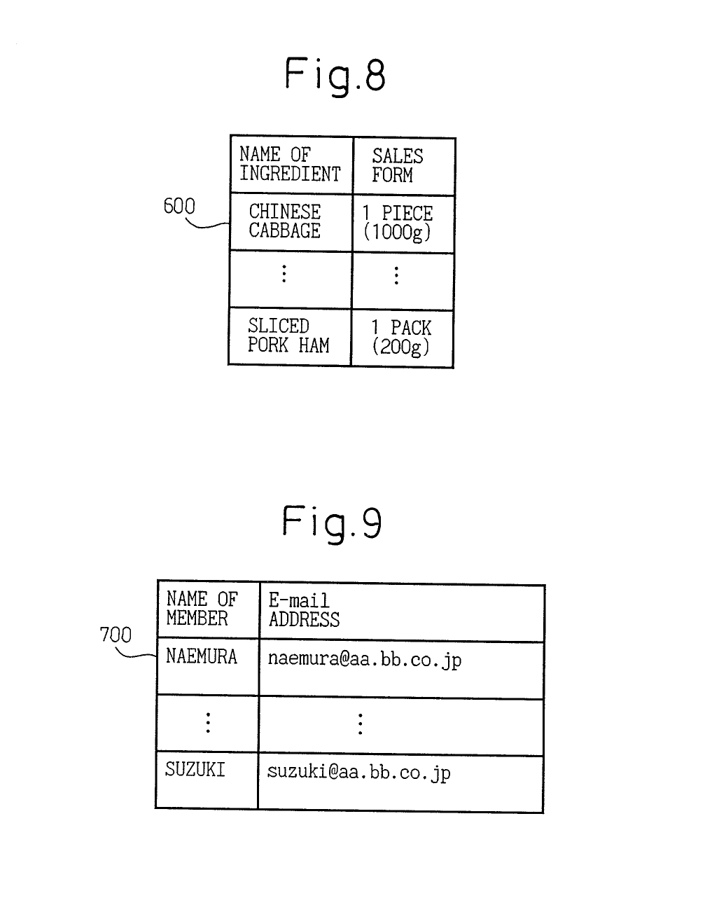

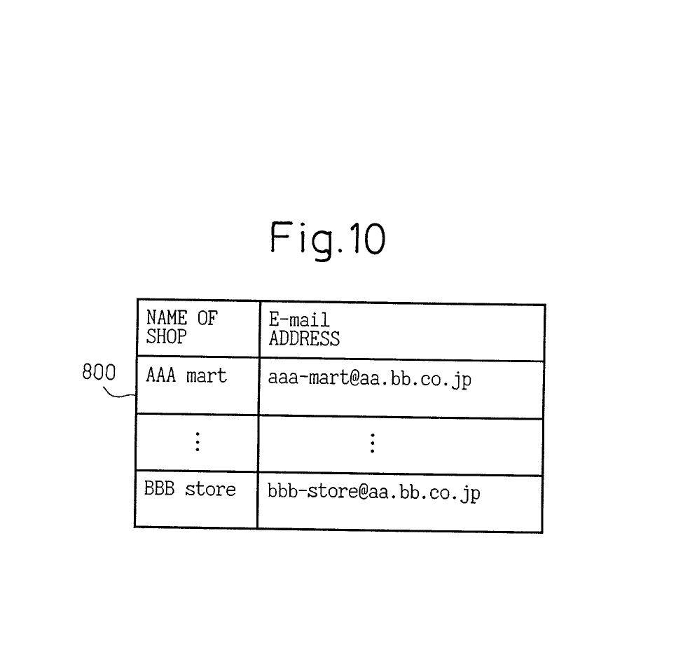

FIG. 2 is a flow chart depicting the whole flow of the process of inquiring to obtain menus using remaining ingredients from the previous menu, FIG. 3 is a flow chart depicting the flow of the process of inquiring to obtain available menus using remaining ingredients, FIG. 6 shows a specific example of the contents of the distribution date DB 111, FIG. 7 shows a specific example of the contents of the menu DB 120, FIG. 8 shows a specific example of the contents of the sale unit DB 150, FIG. 9 shows a specific example of the contents of the member DB 130, FIG. 10 shows a specific example of the contents of the shop DB 140, and FIG. 11A to FIG. 11D, FIG. 12A, FIG. 12B show specific examples of the image on the screen of a member terminal.

Below is described, with reference to FIG. 2, the operation of the ingredient information managing apparatus 100 inquiring the menus using remaining ingredients, which computes the information about the new menus using the ingredients presumed to remain when preparing the last dish.

At first, the ingredient information managing apparatus 100 receives menus from TV stations (S190). The received menus are linked with, for example, TV cooking programs.

The ingredient information managing apparatus 100 transmits the menus to the member terminals 160, and, at the same time, transmits the menus and the number of destinations of the menus to the shop terminals 180 (S230). The menus include the names and amounts of the ingredients, and the information transmitted to the shop terminals 180 further includes the number of destinations of the menus. The member terminal 160 which has received the menus displays the menus (S200). The shop terminal 180 which has received the menus stores the menus in the memory for computing expected sales (S270).

The reference numeral 900 shown in FIG. 11A denotes the image on the screen of the member terminal 160 which has received the menus from the ingredient information managing apparatus 100 (S200). The reference numeral 910 shown in FIG. 11B denotes the image on the screen of the member terminal 160 after more detailed information has been required. The reference numeral 700 shown in FIG. 9 denotes the member DB 130 (see FIG. 1) in which the information about two members has been stored in advance. The information includes the names, “Naemura” and “Suzuki”, of the two members, and the E-mail addresses, “HYPERLINK mailto:naemura@aa.bb.co.jp” and “HYPERLINK mailto:suzuki@aa.bb.co.jp” of the two members where the information from the ingredient information managing apparatus 100 is transmitted. The reference numeral 800 shown in FIG. 10 denotes the shop DB 140 (see FIG. 1) in which the information about two shops has been stored in advance. The information includes the names, “AAA mart” and “BBB store” of the two shops, and the E-mail addresses, “HYPERLINK mailto:aaa-mart@aa.bb.co.jp” and “HYPERLINK mailto:bbb-store@aa.bb.co.jp”, of the two shops where the information from the ingredient information managing apparatus 100 is transmitted.

When the member inquires the new menus using the ingredients presumed to remain when preparing the dishes of the above menus, the member transmits the request of inquiring menus using the remaining ingredients to the ingredient information managing apparatus 100 through the member terminal 160 (S210). The information about the request of inquiring menus includes the distribution dates of the above menus input through the member terminal 160 by the member. The reference numeral 400 shown in FIG. 6 denotes the distribution date DB 111 (see FIG. 1) in which the distribution information to be distributed to the member terminals 160 and the shop terminals 180 has been stored in advance. The distribution information includes the distribution dates, “June 1” and “June 30”, and the menus, “Hamburger”, “Green Salad”, and “Onion Soup” distributed on June 1, and “Chop Suey”, “Egg Roll”, and “Tomato Salad” distributed on June 30. The reference numeral 920 shown in FIG. 11C denotes the image on the screen of the member terminal 160 by which the member transmits the request of inquiring the menus using the remaining ingredients to the ingredient information managing apparatus 100.

The ingredient information managing apparatus 100 which has received the above request of inquiring the menus at the step S240 searches out, at the step S250, the menus using the remaining ingredients, while referring to the distribution date DB 111, menu DB 120, and sale unit DB 150 shown in FIG. 1, by using the above distribution dates included in the above request of inquiring the menus as the input information. The reference numeral 500 shown in FIG. 7 denotes the menu DB 120 in which the menu information has been stored in advance. The menu information includes the names of the menus “Chop Suey” and “Chinese cabbage boiled with cream”, ingredient 1 and the amount thereof, “Chinese cabbage: 500 g” and “Chinese cabbage: 500 g”, ingredient 2 and the amount thereof, “Sliced pork ham: 50 g” and “Tuna: 1 can (135 g)”, ingredient n and the amount thereof, “Shrimp: 8” and “milk: 500 cc”, seasoning 1 and the amount thereof, “Shoyu: 1.5 large spoon” and “Salt: ½ small spoon”, seasoning n and the amount thereof, “Sake for cooking: 1.5 large spoon” and “Dogtooth Violet Starch: 1 large spoon”, and the recipes, “1. After heating a pot without anything in it - - - ” and “1. Boil Chinese cabbage - - - ”. The reference numeral 600 shown in FIG. 8 denotes the sale unit DB 150 in which the sale unit information about ingredients has been stored in advance. The sales form information includes the names of the ingredients, “Chinese cabbage” and “Sliced pork ham”, and the sales forms, “1 piece (1000 g)” and “1 pack (200 g)” for “Chinese cabbage” and “Sliced pork ham” respectively.

The ingredient information managing apparatus 100 then transmits, at the step S260, the searched menus using the remaining ingredients to the member terminal 160, and, at the same time, transmits the searched menus using the remaining ingredients to the shop terminal 180. The information about the menus using the remaining ingredients includes the names and amounts of the ingredients for each of the menus. The member terminal 160 and the shop terminal 180 receive the menus using the remaining ingredients (member terminal: steps S220, shop terminal: S280). The member terminal 160 which has received the menus using the remaining ingredients displays the menus using the remaining ingredients (S220). The shop terminal 180 which has received the menus using the remaining ingredients stores the menus using the remaining ingredients in the memory for computing expected sales (S280). The reference numeral 930 shown in FIG. 11D denotes the image on the screen of the member terminal 160 which has received the menus using the remaining ingredients from the ingredient information managing apparatus 100, and the reference numeral 940 shown in FIG. 12A denotes the image on the screen of the member terminal 160 which has required more detail information.

Below is described, with reference to FIG. 3, the operation of the ingredient information managing apparatus 100 inquiring information about the menus using remaining ingredients.

At the step S300, the ingredient information managing apparatus 100 determines whether the distribution date included in the request of inquiring information about the menus using the remaining ingredients exists in the distribution date DB 111. If the result of the determination at the step S300 is that the distribution date included in the request of inquiring the menus using the remaining ingredients exists in the distribution date DB 111, the process of searching out the remaining ingredients, the detailed flow of which will be described later, is performed (S310). If the result of the determination at the step S300 is that the distribution date included in the request of inquiring the menus using the remaining ingredients does not exist in the distribution date DB 111, the message saying that an appropriate menu was not found is prepared (S316). The reference numeral 950 shown in FIG. 12B denotes the image on the screen of the member terminal 160 which has received, from the ingredient information managing apparatus 100, the message saying that an appropriate menu was not found.

After the step S310, it is determined whether the remaining ingredients exist in the memory for remaining ingredients (S312). If the result of the determination at the step S312 is that the remaining ingredients exist in the memory for remaining ingredients, the process of searching out an available menu using the remaining ingredients, the detail flow of which will be described later, is performed (S313). If the result of the determination at the step S312 is that any one of the remaining ingredients does not exist in the memory for remaining ingredients, the message saying that an appropriate menu was not found is prepared (S316).

After the step S313, it is determined whether the menu using the remaining ingredients exists in the memory for menus using remaining ingredients (S314). If the result of the determination at the step S314 is that the menu using the remaining ingredient exists in the memory for menus using remaining ingredients, the message expressing the menu using the remaining ingredient is prepared (S315). If the result of the determination at the step S314 is that the menu using the remaining ingredient does not exist in the memory for menus using remaining ingredients, the message saying that an appropriate menu was not found is prepared (S316).

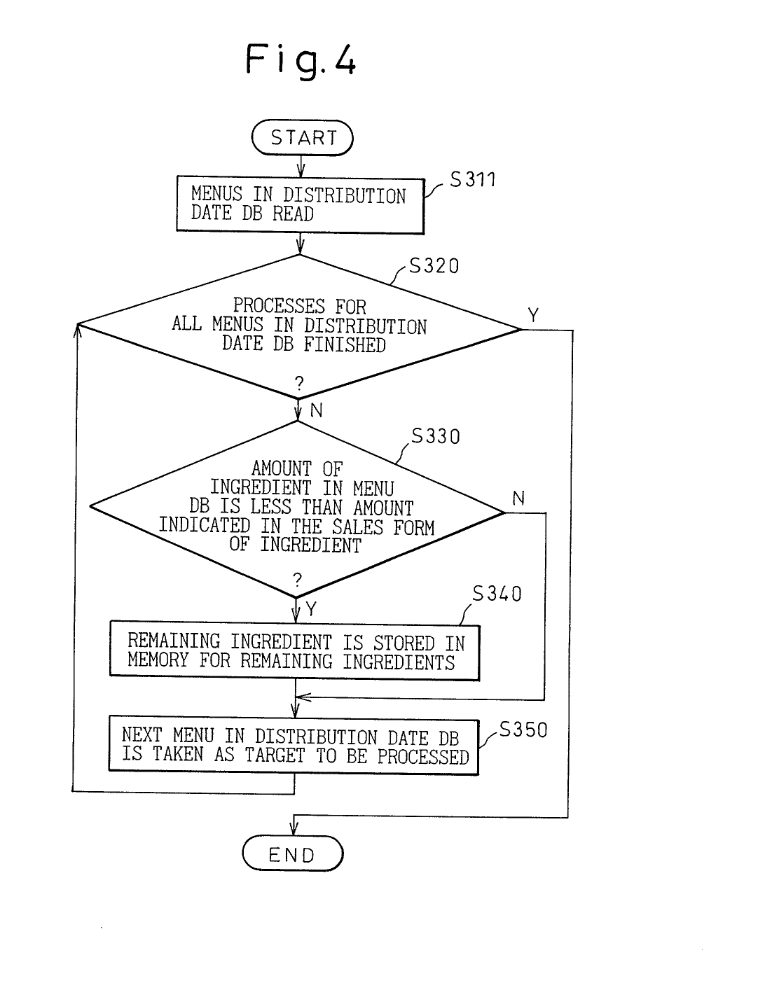

Below is described, with reference to FIG. 4, the operation of the ingredient information managing apparatus 100 searching out useful ingredients from the remaining ingredients. At the step S311, the menus in the distribution date DB 111 are read. At the step S320, it is determined whether there is a menu in the menu DB 120 which matches the menu in the distribution date DB 111. If the result of the determination at the step S320 is that there is a menu in the menu DB 120 which matches the menu in the distribution date DB 111, namely, if processes of steps S330, S340 and S350 for all menus in distribution DB 111 have not been finished, it is determined whether the amount of the ingredient of the menu is less than the amount indicated in the sales form of the ingredient in the sale unit DB 150 (S330). If the result of the determination at the step S320 is that there is no menu in the menu DB 120 which matches the menu in the distribution date DB 111, it is recognized that there is no remaining ingredient, and the process is finished.

At the step S330, it is determined whether the amount of the ingredient of the menu is less than the amount indicated in the sales form of the ingredient in the sale unit DB 150. If the result of the determination at the step S330 is that the amount of the ingredient of the menu is less than the amount indicated in the sales form of the ingredient in the sale unit DB 150, the ingredient of the menu is recognized as the remaining ingredient and is stored in the memory for remaining ingredients (S340), and then the menu index is renewed to retrieve the next menu of the same distribution date (S350). If the result of the determination at the step S330 is that the amount of the ingredient of the menu is larger than the amount indicated in the sales form of the ingredient in the sale unit DB 150, the ingredient of the menu is not recognized as the remaining ingredient, and the next menu in the distribution date DB 111 for retrieving the menu DB 120 is taken as a target to be processed (S350), and then the process returns to the step S320.

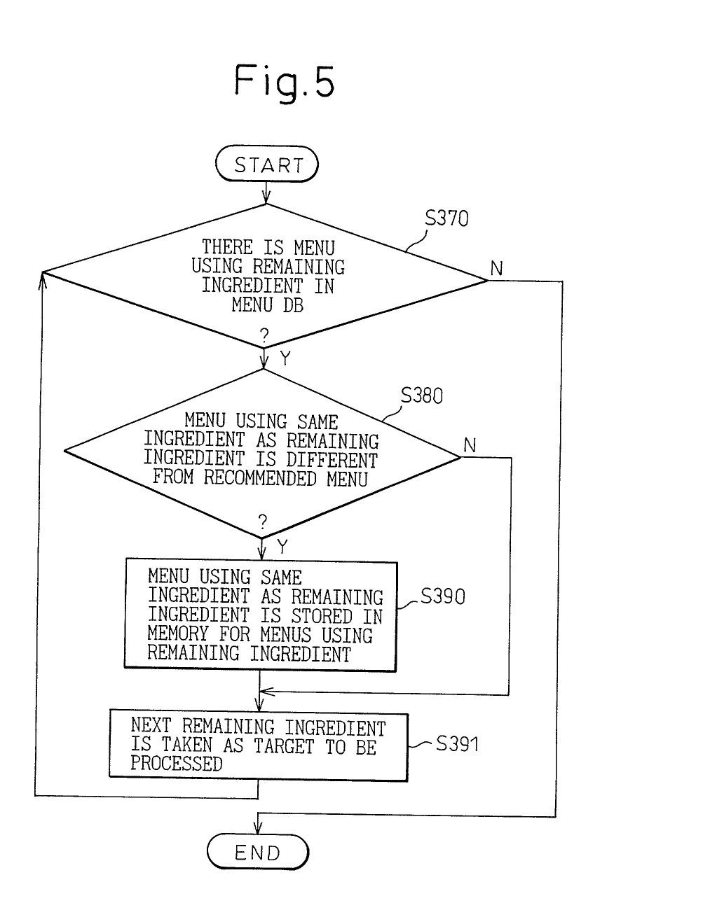

Below is described, with reference to FIG. 5, the operation of the ingredient information managing apparatus 100 searching out available menus using the remaining ingredients.

At the step S370, it is determined whether there is a menu using the ingredient in the menu DB 120 which matches the remaining ingredient in the memory for remaining ingredients. If the result of the determination at the step S370 is that there is a menu using the ingredient in the menu DB 120 which matches the remaining ingredient in the memory for remaining ingredients, it is determined whether the menu using the same ingredient as the remaining ingredient is different from the recommended menu corresponding to the distribution date regarding the inquiry (S380). If the result of the determination at the step S370 is that there is no menu using the ingredient in the menu DB 120 which matches the remaining ingredient in the memory for remaining ingredients, it is recognized that there is no menu using the remaining ingredient, and the process is finished.

If the result of the determination at the step S380 is that the menu using the ingredient is different from the recommended menu corresponding to the distribution date regarding the inquiry, the menu using the same ingredient as the remaining ingredient is stored in the memory for the menus using remaining ingredients (S390), and then the remaining ingredient index on the work memory for retrieving the menu DB 120 is renewed (S391). If the result of the determination at the step S380 is that the menu using the ingredient is identical with the recommended menu corresponding to the distribution date regarding the inquiry, the remaining ingredient index pointer on the work memory for retrieving the menu DB 120 is renewed (S391).

Next, the process of the shop terminal 180 in this embodiment will be described with reference to the figures.

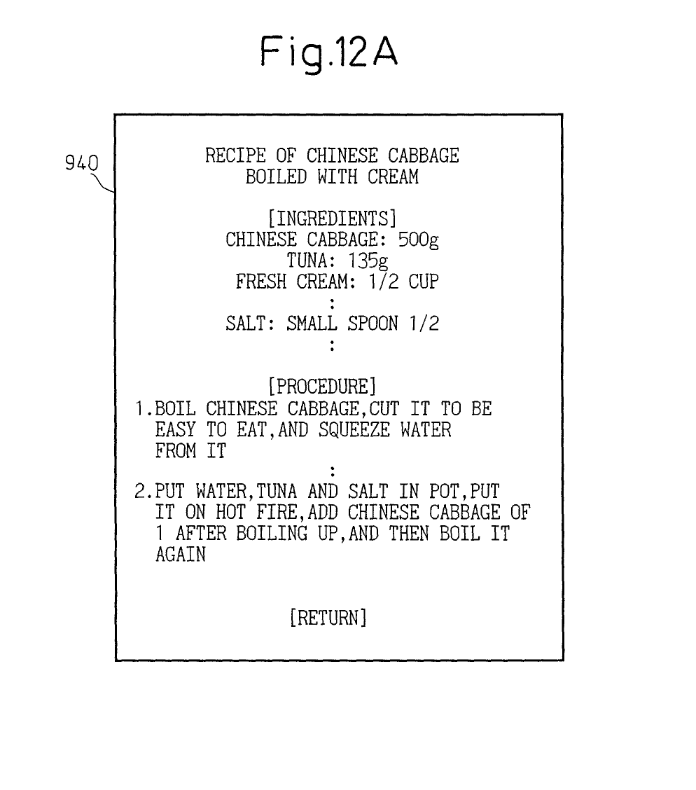

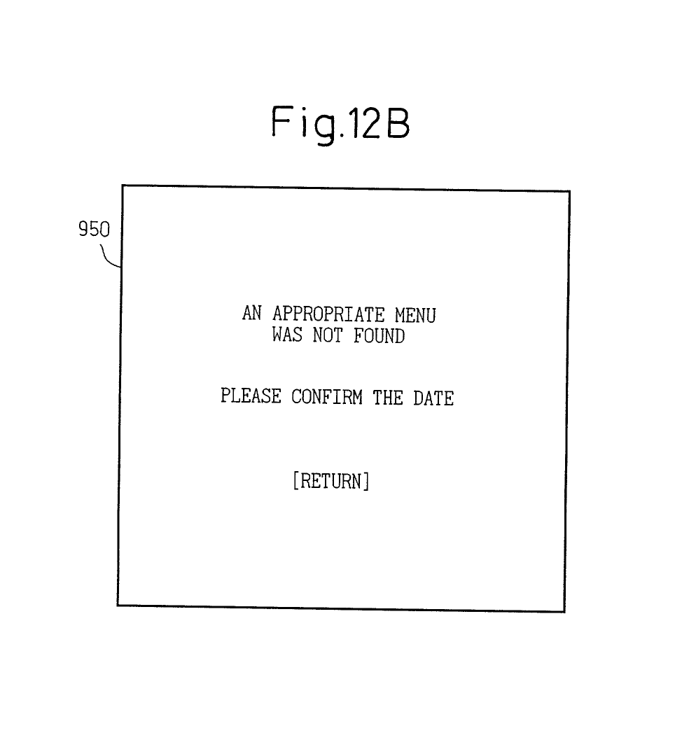

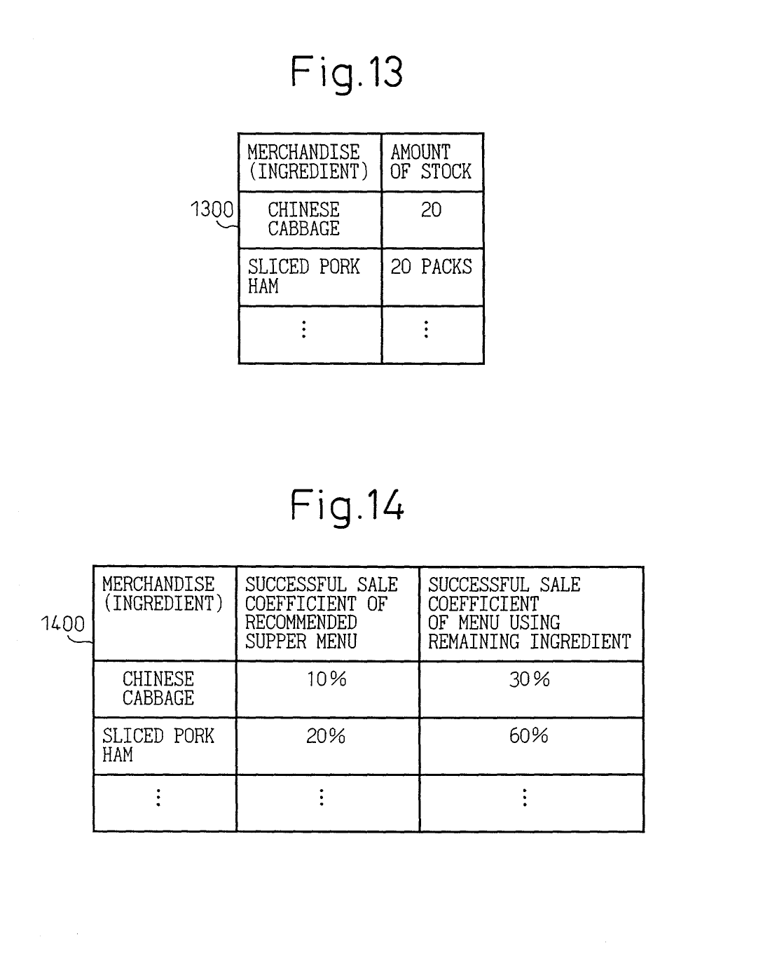

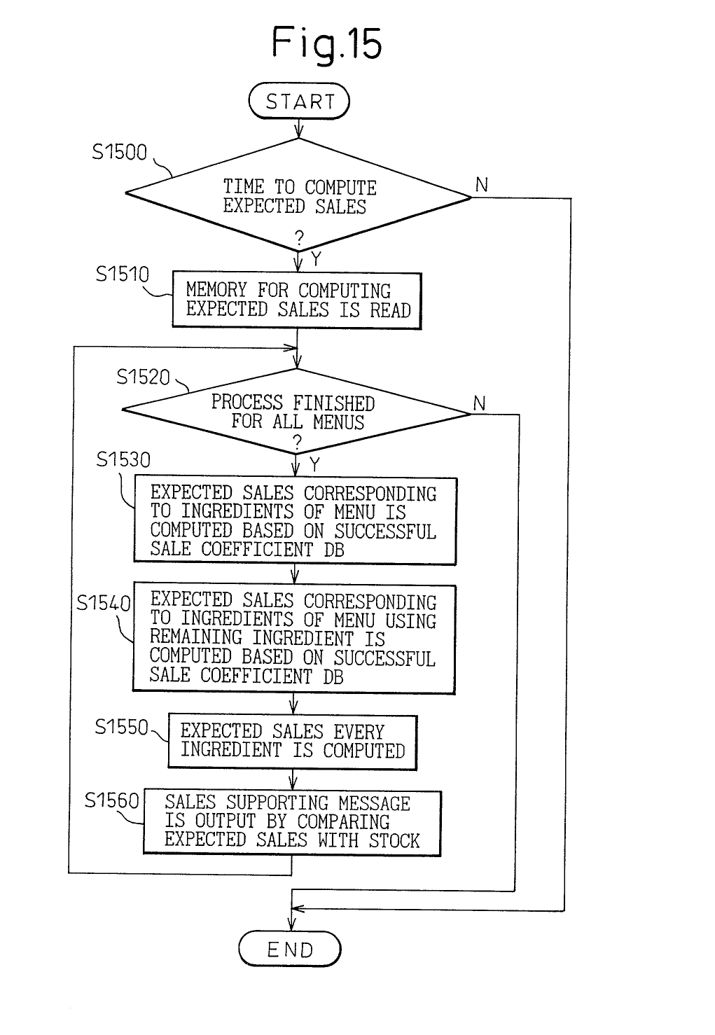

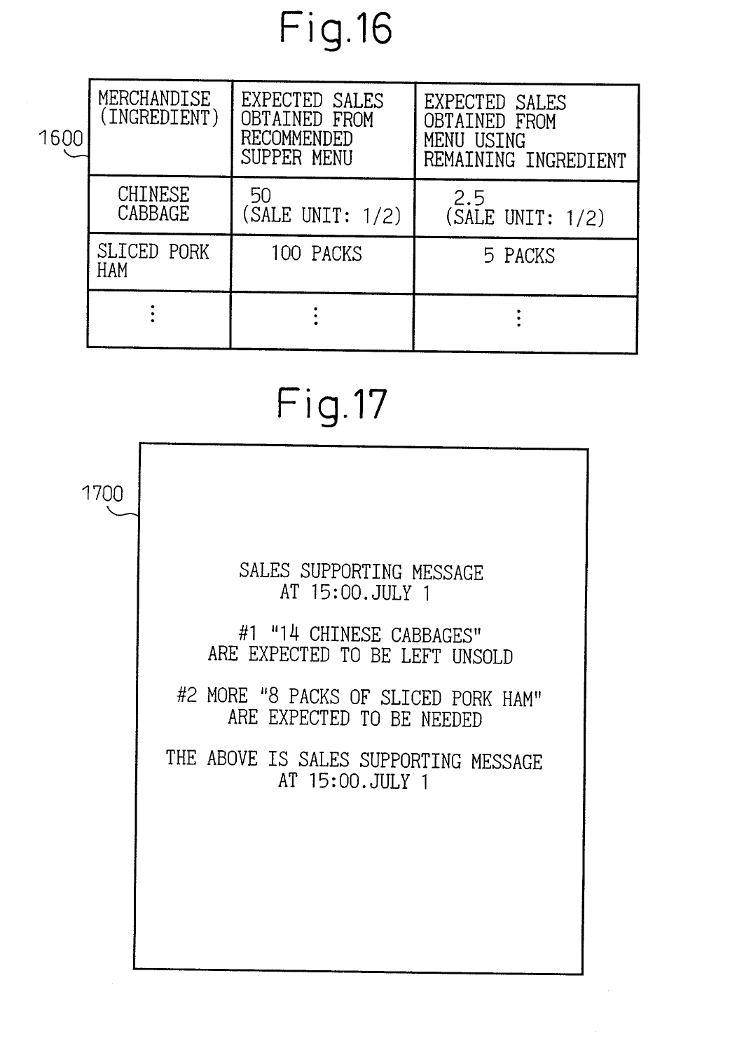

Below is described, with reference to FIG. 1, FIG. 2, and FIG. 13 to FIG. 17, the process of the shop terminal 180 receiving the information about menus and the information about the menu using the remaining ingredients from the ingredient information managing apparatus 100, and outputting the sales supporting message shown in FIG. 2 (S290) while referring the stock-for-network-sale DB 182 and the successful sale coefficient DB 183. FIG. 13 shows a specific example of the contents of the stock-for-network-sale DB 182, FIG. 14 shows a specific example of the contents of the successful sale coefficient DB 183, FIG. 15 is a flow chart depicting the flow of the process of outputting a sales supporting message, FIG. 16 shows a specific example of the contents of the memory for computing expected sales in a shop terminal 180, and FIG. 17 shows a specific example of the image on the screen of a shop terminal 180.

Below is described, with reference to FIG. 2, the operation of the shop terminal 180 receiving the information about menus and the information about the menus using the remaining ingredients from the ingredient information managing apparatus 100, and of outputting the sales supporting message.

The shop terminal 180 receives the information about menus transmitted from the ingredient information managing apparatus 100 at the step S230, receives the information about the menus using the remaining ingredients transmitted from the ingredient information managing apparatus 100 at the step S260, and outputs the sales supporting message while referring to the stock-for-network-sale DB 182 (see FIG. 1) and to the successful sale coefficient DB 183 (see FIG. 1) at step S290.

The reference numeral 1300 shown in FIG. 13 denotes the stock-for-network-sale DB 182 in which the names of merchandise, “Chinese cabbage” and “Sliced pork ham”, and the amounts of stock, “20” and “20 packs” corresponding to the above merchandise respectively have been stored in advance.

The reference numeral 1400 shown in FIG. 14 denotes the successful sale coefficient DB 183 in which the names of merchandise, “Chinese cabbage” and “Sliced pork ham”, the successful sale coefficients, “10%” and “20%” of the recommended supper menu corresponding to the above merchandises respectively, and the successful sale coefficients, “30%” and “60%” of the menus using the remaining ingredient corresponding to the above merchandises respectively, have been stored in advance.

Below is described, with reference to FIG. 15, the operation of the shop terminal 180 outputting a sales supporting message. FIG. 16 shows the image of the contents in the memory for computing expected sales showing that the recommended supper menu on June 30 is distributed to 100 members and the number of the inquiries about the menu using the remaining ingredient on June 30 is 5.

In the column “Expected sales obtained from the recommended supper menu” of the image 1600 shown in FIG. 16, the total amounts of ingredients of the recommended supper menu are shown. The total amount of the ingredient is the product of the amount of the ingredient and the number of the distributions of the recommended supper menu, and is stored in the memory for computing expected sales. In case that the ingredients used for the recommended supper menu in the menus received at the step S270 are “500 g (a half)” of “Chinese cabbage” and “one pack” of “sliced pork ham”, and the number of the distributions of the recommended supper menu is 100, the total amount of “Chinese cabbage” is “50”, and the total amount of “sliced pork ham” is “100 packs”.

At the step S1500 shown in FIG. 15, it is determined whether the clock of the shop terminal has indicated the time to compute expected sales. The time to compute expected sales has been set in the shop terminal by the clerk.

If the result of the determination at the step S1500 is that the clock of the shop terminal has indicated the time to compute expected sales, the menus received at the step S270 and the menus using the remaining ingredients received at the step S280 stored in the memory for computing expected sales are read at the step S1510.

If the result of the determination at the step S1500 is that the clock of the shop terminal has not indicated the time to compute expected sales, the process is finished.

At the step S1520, it is determined whether the output of the sales supporting message caused by the information in the memory for computing expected sales has been finished for all of the menus.

If the result of the determination at the step S1520 is that the output of the sales supporting message caused by the information in the memory for computing expected sales has not been finished for all of the menus, the expected sales of successful sale corresponding to the ingredient of the menu is computed at the step S1530.

If the result of the determination at the step S1520 is that the output of the sales supporting message caused by the information in the memory for computing expected sales has been finished for all of the menus, the process is finished.

At the step S1530, the expected sales of the ingredients of the menu which have been purchased according to the menu received by the shop terminal to which the menu has been distributed are computed based on the product of the amounts of ingredients and the number of distributions of the menu received at the step S270, and the expected sales of the ingredients of the menu are computed based on the product of the expected sales of the ingredients of the menu and the successful sale coefficients of the menu in the successful sale coefficient DB 183.

In the column “Expected sales obtained from the recommended supper menu” of the image 1600 shown in FIG. 16, the total amounts of ingredients of the recommended supper menu are shown. The total amount of the ingredient is the product of the amount of the ingredient and the number of the distributions of the recommended supper menu, and is stored in the memory for computing expected sales. In case that the ingredients used for the recommended supper menu in the menus received at the step S270 are “500 g (a half)” of “Chinese cabbage” and “one pack” of “sliced pork ham”, and the number of the distributions of the recommended supper menu is 100, the total amount of “Chinese cabbage” is “50”, and the total amount of “sliced pork ham” is “100 packs”

At the step S1540, the expected sales of the ingredients of the menu using the remaining ingredients is computed by taking the amounts of the ingredients for the menu using the remaining ingredients which have been stored in the memory for computing expected sales every time the menu using the remaining ingredients has been received, as the expected sales of the ingredients of the menus using the remaining ingredients which have been purchased according to the menu using the remaining ingredients received by the shop terminal to which the menu has been distributed, and based on the product of the expected sales of the ingredients of the menu using the remaining ingredient and the successful sale coefficient of the menu using the remaining ingredients in the successful sale coefficient DB 183 corresponding to the ingredients of the menu using the remaining ingredients.

In the column “Expected sales obtained from the menu using the remaining ingredient” of the image 1600 shown in FIG. 16, the total amounts of ingredients of the menu using the remaining ingredient are shown. The total amount of the ingredient is the product of the amount of the ingredient and the number of the inquiries of the menu using the remaining ingredient, and is stored in the memory for computing expected sales. In case that the ingredients used for a certain dish in the menu using the remaining ingredient received at the step S280 are “500 g (a half)” of “Chinese cabbage” and “one pack” of “sliced pork ham”, and the number of the inquiries of the menu using the remaining ingredient is 5, the total amount of Chinese cabbage is “2.5”, and the total amount of “sliced pork ham” is “5 packs”.

At the step S1550, the final “expected sales” for every ingredient at the time to compute expected sales is computed by adding the expected sales of the ingredient of the menu computed at the step S1530 to the expected sales of the ingredient of the menu using the remaining ingredient computed at the step S1540.

At the step S1560, the sales supporting message is output by comparing the expected sales for every ingredient computed at the step S1550 with the “the amount of the stock” in the stock-for-network-sale DB 182 corresponding the above merchandise.

The reference numeral 1700 shown in FIG. 17 denotes the image on the screen of the sales supporting message obtained, at 15:00 on July 1, the time to compute expected sales, by comparing the above expected sales computed based on the collected data with the above “the amount of the stock” in the stock-for-network-sale DB 182. As for “Chinese cabbage”, the difference between “6” of the expected sales and “20” of the amount of the stock of “Chinese cabbage” in the stock-for-network-sale DB 182 is computed, and the message saying that “14 Chinese cabbages” are expected to be left unsold is displayed. As for “Sliced pork ham”, the difference is computed like “Chinese cabbage”, and the message saying that “3 packs of sliced pork ham” are expected to be left unsold is indicated.

[Effect of the Invention]

The first problem is solved with an ingredient information management apparatus according to the present invention. The ingredient information management apparatus may search out the information about new dishes using the ingredients assumed to remain after the last cooking based on the menu discrimination information received from a member, the distribution date DB 111, menu DB 120, sale unit DB 150 member DB 130, and shop DB 140, thus allowing the member to obtain a combination of the information about new dishes using the ingredients which remain after the last cooking without setting the condition including the ingredients which remain.

The second problem is solved with a shop terminal according to the present invention. The shop terminal may output the sales supporting message based on the information about menus and the information about the menus using the remaining ingredients received from the ingredient information management apparatus, the stock-for-network-sale DB 182, and the successful sale coefficient DB 183, thus allowing a clerk of the shop to obtain the information effective in promoting the sale of the merchandise automatically without performing special operations.

What is claimed is:

1. An ingredient information management apparatus comprising:
a means for receiving the menu discrimination information input through member terminals;
a menu storage means for storing discrimination information and amounts of ingredients corresponding to the discrimination information for every menu;
an ingredient amount searching means for searching out the ingredients and the amounts thereof, from the menu storage means, corresponding to said menu discrimination information;
a sale unit storage means for storing a sale unit for every ingredient;
a sale unit searching means for searching out a sale unit, from the sale unit storage means, corresponding to an ingredient searched out by the ingredient amount searching means;
a comparing means for comparing the amount of said ingredient searched out by the ingredient amount searching means with the sale unit searched by the sale unit searching means; and
a menu information searching means for searching out the menu information, from the menu storage means, including said ingredient in case that said amount of said ingredient is less than said sale unit as a result of the comparison by the comparing means.

2. An ingredient information management method comprising:
a step of receiving the menu discrimination information input through a member terminal;
an ingredient amount searching step of searching out the ingredients and the amounts thereof, from a menu storage means for storing discrimination information and amounts of ingredients corresponding to the discrimination information for every menu, corresponding to said menu discrimination information;
a sale unit searching step of searching out, from a sale unit storage means for storing a sale unit for every ingredient, a sale unit corresponding to the ingredient searched at the ingredient amount searching step;
a comparing step of comparing the amount of said ingredient searched at the ingredient amount searching step with the sale unit searched at the sale unit searching step; and
a menu information searching step of searching out the menu information, from the menu storage means, including said ingredient in case that the amount of said ingredient is less than said sale unit as a result of the comparison at the comparing step.

3. A program allowing a computer to execute:
a step of receiving the menu discrimination information input through a member terminal;
an ingredient amount searching step of searching out the ingredients and the amounts thereof, from a menu storage means for storing discrimination information and amounts of ingredients corresponding to the discrimination information for every menu, corresponding to said menu discrimination information;
a sale unit searching step of searching out, from a sale unit storage means for storing a sale unit for every ingredient, a sale unit corresponding to the ingredient searched at the ingredient amount searching step;
a comparing step of comparing the amount of said ingredient searched at the ingredient amount searching step with the sale unit searched at the sale unit searching step; and
a menu information searching step of searching out the menu information, from the menu storage means, including said ingredient in case that the amount of said ingredient is less than said sale unit as a result of the comparison at the comparing step.

4. A computer readable storage medium which stores a program allowing a computer to execute:
a step of receiving the menu discrimination information input through a member terminal;
an ingredient amount searching step of searching out the ingredients and the amounts thereof, from a menu storage means for storing discrimination information and amounts of ingredients corresponding to the discrimination information for every menu, corresponding to said menu discrimination information;
a sale unit searching step of searching out, from a sale unit storage means for storing a sale unit for every ingredient, a sale unit corresponding to the ingredient searched at the ingredient amount searching step;
a comparing step of comparing the amount of said ingredient searched at the ingredient amount searching step with the sale unit searched at the sale unit searching step; and
a menu information searching step of searching out the menu information, from the menu storage means, including said ingredient in case that the amount of said ingredient is less than said sale unit as a result of the comparison at the comparing step.

5. A expected sales computing apparatus comprising:
a successful sale coefficient storage means for storing the successful sale coefficients representing the probability of purchasing the ingredients of a first menu and the successful sale coefficient representing the probability of purchasing the ingredients of a second menu inquired in relation to the first menu;
a means for computing the expected sales of the ingredients of the first menu based on the ingredients of the first menu, the number of the distributions of the first menu, and the successful sale coefficient of the first menu searched out, from a successful sale coefficient storage means; and
a means for computing the expected sales of the ingredients of the second menu based on the ingredients of the second menu, number of the inquiries of the second menu, and the successful sale coefficient of the second menu searched out, from the successful sale coefficient storage means.

6. A expected sales computing method comprising:
a step of computing the expected sales of the ingredients of a first menu based on the ingredients of the first menu, the number of the distributions of the first menu, and the successful sale coefficients of the first menu searched out, from a successful sale coefficient storage means for storing the successful sale coefficients representing the probabilities of purchasing the ingredients of the first menu; and
a step of computing the expected sales of the ingredients of a second menu based on the ingredients of the second menu inquired in relation to the first menu, number of the inquiry of the second menu, and the successful sale coefficient of the second menu searched out, from a successful sale coefficient storage means for storing the successful sale coefficients representing the probability of purchasing the ingredients of the second menu.

7. A program allowing a computer to execute:
a step of computing the expected sales of the ingredients of a first menu based on the ingredients of the first menu, the number of the distributions of the first menu, and the successful sale coefficients of the first menu searched out, from a successful sale coefficient storage means for storing the successful sale coefficients representing the probabilities of purchasing the ingredient for the first menu; and
a step of computing the expected sales of the ingredient for the second menu based on the ingredients of a second menu inquired in relation to the first menu, number of the inquiries of the second menu, and the successful sale coefficient of the second menu searched out, from a successful sale coefficient storage means for storing the successful sale coefficients representing the probability of purchasing the ingredients of the second menu.

8. A computer readable storage medium which stores a program allowing a computer to execute:
a step of computing the expected sales of the ingredients of a first menu based on the ingredients for the first menu, the number of the distributions of the first menu, and the successful sale coefficients of the first menu searched out, from a successful sale coefficient storage means for storing the successful sale coefficients representing the probabilities of purchasing the ingredients of the first menu; and
a step of computing the expected sales of the ingredients of the second menu based on the ingredients for a second menu inquired in relation to the first menu, number of the inquiries of the second menu, and the successful sale coefficients of the second menu searched out, from a successful sale coefficient storage means for storing the successful sale coefficients representing the probability of purchasing the ingredients for the second menu.

9. An ingredient information management apparatus comprising:
a means for transmitting the ingredients of a first menu and the number of the distributions of the first menu to a user terminal, and
a means for transmitting the ingredients of a second menu inquired in relation to the first menu and the number of the inquiries of the second menu to a user terminal.

10. An ingredient information management method comprising:
a step of transmitting the ingredients of a first menu and the number of the distributions of the first menu to a user terminal, and
a step of transmitting the ingredients of a second menu inquired in relation to the first menu and the number of the inquiries of the second menu to a user terminal.

11. A program allowing a computer to execute:
a step of transmitting the ingredients of a first menu and the number of the distributions of the first menu to a user terminal, and
a step of transmitting the ingredients of a second menu inquired in relation to the first menu and the number of the inquiries of the second menu to a user terminal.

12. A computer readable storage medium for storing a program allowing a computer to execute:
a step of transmitting the ingredients of a first menu and the number of the distributions of the first menu to a user terminal, and
a step of transmitting the ingredients of a second menu inquired in relation to the first menu and the number of the inquiries of the second menu to a user terminal.
